(19) United States
(12) Patent Application Publication
(10) Pub. No.: US 2013/0110664 A1
(43) Pub. Date: May 2, 2013

(54) One-To-Many, Double-Sided Online Auction

(71) Applicants: Peter J. Bellomo, Frederick, MD (US); Matthew S. Shives, Hagerstown, MD (US); David B. Banks, Aliso Viejo, CA (US)

(72) Inventors: Peter J. Bellomo, Frederick, MD (US); Matthew S. Shives, Hagerstown, MD (US); David B. Banks, Aliso Viejo, CA (US)

(73) Assignee: PropertyRoom.com, Inc., Frederick, MD (US)

(21) Appl. No.: 13/281,520

(22) Filed: Oct. 26, 2011

(51) Int. Cl. G06Q 30/08

(52) U.S. Cl. 705/26.3

(57) ABSTRACT

Systems, methods and computer program products for facilitating the operations of an online one-to-many, double-sided auction are disclosed. In an aspect of the present invention, a system includes an automated system configured to provide an ask price for an item presented in an auction, via a network, to a plurality of computing devices being utilized by a plurality of bidders and configured to receive, via the network, a plurality of bids for the item; and wherein the automated system terminates the auction in response to a termination condition. A termination condition is, for example, a bid-ask match (where a bid is greater than or equal to the ask price) or an auction time clock expiration.

### BACKGROUND OF THE INVENTION

1. Field of the Invention

The present invention generally relates to auction formats, and more particularly to systems, methods and computer program products for facilitating auctions over a network involving negotiations that employ game mechanics to enhance participation and outcome.

2. Related Art

Among the plethora of commercial sites on the Internet are many “auction” sites, where items (often items that do not have a clear-cut market price such as, for example, used items) are sold by using various auction methods. A common format is an online version of the “English Auction,” where buyers may place bids on an item that is offered for sale until a timer runs out. After the timer runs out, the highest bidder will receive the item for the value of his or her bid. Unfortunately, this sales method allows the seller little say in the final price of the item, even when a “reserve price” (i.e., a price below which the seller will not allow the item to be sold) is implemented.

Another sales method common in real estate transactions, in business-to-business sales, and, iconically, in bazaars, is the practice of “negotiation” or “haggling,” where the seller and a single buyer both offer prices for the item until one party decides to cease negotiating or one party accepts the other party's offer of a price for the item. This sales method increases the seller's say in the price determination process. This method, however, is also deficient in that the seller only interacts with one prospective buyer at a time. As a result, the seller may ultimately sell the item at a lower price than that which another prospective buyer may have been willing to pay, and the lack of competitive bidding from multiple buyers lengthens the time required to reach a final price and close the sale.

Although the standard “English Auction” does allow multiple buyers to be involved in the process, a similar disadvantage to the “English Auction” becomes plain in an auction where a buyer places a high bid price early in the auction and this bid price ultimately ends up as the final price; yet per typical auction rules, the allotted time must be allowed to elapse before the auction closes because the seller has made a commitment to keep the bid open until a preset time elapses. Buyers are disadvantageously forced to continue to check the auction to ensure that no one outbids them for the remaining time, which may be hours, days or even weeks in the future. Because the preset time must expire before the auction closes, the seller can disadvantageously suffer from sub-optimal inventory velocity.

Regardless of the auction formats or methodologies currently employed online via a network such as the global, public Internet (e.g., English auctions, penny auctions, Dutch auctions, the “name your price” approach, or other price determination methodologies), they all have the limitation of being single-sided auctions. That is, single-sided auctions are those that rely on bidders to engage against each other while the system (or seller) keeps a tally of the bid prices and publishes the bid results without engaging or negotiating with bidders on the price. As a result, these conventional online auction formats are disadvantageously one-sided in nature. For example, in these conventional online auction formats, the seller is not able to negotiate descending “ask prices” (i.e., prices asked by seller) in response to ascending bid prices from multiple buyers simultaneously in regards to a single item to be sold. This one-sided limitation typically depresses ultimate sale prices and extends transaction times.

In sum, existing auction formats are not able to simulate a rational human seller who would have asymmetric knowledge (e.g., reasonable human reasoning, non-quantifiable considerations, rational reasoning, and/or logical reasoning) that takes into account various adjustable parameters such as, for example, item/service cost, acceptable minimum price to simultaneously negotiate with multiple prospective buyers, and/or intention to optimize a seller's value function that may be based on price, inventory velocity, and/or other parameters.

As a result, conventional auction formats are not able to both include the seller as an active participant in the price-determination process and allow any number of prospective buyers to be involved. These conventional auction formats, therefore, are not able to achieve a relatively shorter auction length, an increased inventory velocity, and/or an increased satisfactory buyer-seller interaction.

Given the foregoing, systems, methods and computer program products for facilitating online auctions involving negotiations that employ game mechanics with many buyers are needed.

### BRIEF DESCRIPTION OF THE INVENTION

This summary is provided to introduce a selection of concepts. These concepts are further described below in the Detailed Description. This summary is not intended to identify key features or essential features of the claimed subject matter, nor is this summary intended as an aid in determining the scope of the claimed subject matter.

The present invention meets the above-identified needs by providing systems, methods and computer program products for facilitating online auctions involving negotiations employing game mechanics with many buyers to enhance participation and outcome.

In another aspect of the present invention, systems, methods and computer program products for providing an auction format over a network for price-determination through a game mechanics-based negotiation process between the seller and a plurality of buyers are provided.

In yet another aspect of the present invention, a system includes an automated system configured to provide an ask price for an item presented in an auction, via a network, to a plurality of computing devices being utilized by a plurality of bidders and configured to receive, via the network, a plurality of bids for the item; and wherein the automated system terminates the auction in response to a termination condition. A termination condition is, for example, a bid-ask match where a bid is greater than or equal to the ask price (i.e., the bid is at least equal to the ask price) or an auction time expiration for the auction.

In yet another aspect of the present invention, an automated system is configured to perform an automated auction format.

In other aspects of the invention, an automated system can choose and list an item that is to be sold as well, or may on the other hand perform less than all of the aforementioned functions. The functions performed by the automated system will depend at least partly on the programmed functions of the automated system module, hardware elements, and/or firmware elements comprising the automated system.

Various aspects of the invention advantageously provide a method, system and computer program product for selling items over a network that alleviates or resolves difficulties present in current selling methods. Various aspects of the invention advantageously achieve at least the following:

(1) providing the seller an ability to substantially influence the price of sold items while also preserving the buyers' influence;

(2) creating a new type of game-style or competition-style selling environment, which will produce a more engaging buyer experience and an increased buyer satisfaction;

(3) raising the sale price of items by creating a game-type environment that stimulates competition among buyers and between the buyers and the seller;

(4) generating higher levels of buyer satisfaction by reducing the auction length to the time actually necessary for the item to reach its final price;

(5) increasing inventory velocity and therefore capital efficiency for the seller;

(6) providing a negotiation system that can be opened to as many buyers simultaneously as the seller wishes, thus raising profits by allowing increased competition among buyers; and

(7) providing other advantageous features as illuminated by an inspection of the details presented herein.

To achieve at least some of the above advantages, aspects of the invention provide a method, system and computer program product for selling items over a network that allows the seller to actively negotiate the price of an item with many buyers in an “open” process where all bidders can view the offers and counteroffers on the item being auctioned. In other words, an aspect of the invention provides a selling format that is both one-to-many (one seller to multiple buyers) and double-sided, meaning that during the price-determination process, one seller posts ask prices that are visible and applicable to all buyers while a plurality of buyers each places bids that are likewise visible to both the seller and all other buyers, until there is a bid-ask match as defined above or a preset auction time elapses. If the latter occurs, the auction terminates with no sale; if the former occurs, the aforementioned buyer has “won” the item and, by the rules of the auction, must buy the item at the bid-ask match price. In another aspect of the invention, a seller can configure an automated system so that the auction is a less-than-open process where only a subset of all bidders is selected by the seller to view the offers and counteroffers during the auction.

In an aspect, automated system advantageously provides the addition of inventory velocity to the seller value equation. This advantage is not provided by other auction methods that rely on price maximization of items. Automated system advantageously recognizes that a seller may, at times, rationally choose a non-maximum acceptable price (i.e., a price above a minimum acceptable price, or commonly referred to as a “reserve” or “reserve price”) despite market indicators suggesting the availability of a higher price.

In order to realize a higher price, a seller would typically need to give other buyers time to consider and react to competitive buyer bids. There are at least three reasons why a seller would rationally accept a non-maximum price on an auction.

First, a seller would accept a bid greater than or equal to the reserve price and not wait for the maximum market price in order to expedite the transaction close on a first item and allow bidding on a second item, and then subsequently, allow bidding on a third item, and so forth.

Second, a seller may want to reward a bidder with a non-maximum price in order to encourage a repeat in purchasing behavior or introduce a new consumer to an item, thereby allowing the seller to nurture the market in the future.

Third, while a seller may close the sales of some or all items at prices that are less than the market maximum prices, seller may still derive higher value by the efficiency of the sales process (i.e., the seller achieves the sale of more items to the market of buyers in a given time period).

Further features and advantages of the present invention, as well as the structure and operation of various aspects of the present invention, are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a block diagram of an exemplary system for facilitating online auctions involving game-type negotiations with many buyers according to an aspect of the present invention.

FIG. 2 is a flow diagram of an auctioning method according to an aspect of the present invention.

FIG. 3 is a block diagram of an exemplary buyer interface, as seen from a computing device, according to an aspect of the present invention.

FIG. 4 is a block diagram of an exemplary computer system useful for implementing an aspect of the present invention.

### DETAILED DESCRIPTION

The present invention is directed to systems, methods and computer program products for facilitating online auctions involving game mechanics-based negotiations with many buyers to enhance participation and outcome. As used herein, and as will be appreciated by those skilled in the relevant art(s) after reading the description herein, “game mechanics-based” refers to instances where a business (e.g., an application service provider (ASP) offering the tool of the present invention) engages with customers, outside of a game environment, in a manner that uses specific mechanical aspects prevalent in games, such as competitive comparison, scoring, time clocks, leader boards, ranks (novice, beginner, expert, master), etc.

### System

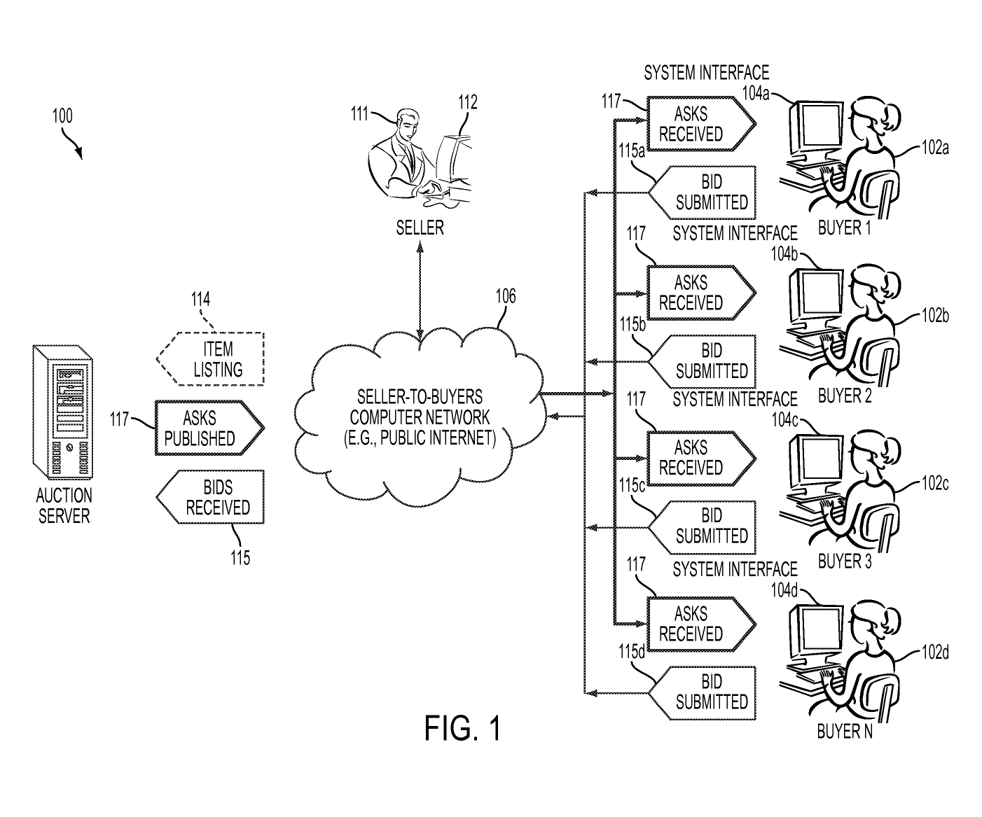

Referring to FIG. 1, a block diagram illustrating an exemplary communication system 100, according to an aspect of the present invention, is shown. System 100 includes a plurality of individuals 102 (shown as buyers 102a-d in FIG. 1) accessing, via a computing device 104 (shown as respective computing devices 104a-d in FIG. 1), a communications network 106, such as, for example, the global, public Internet or another suitable communication network. Network 106 can be formed by electronic, electromagnetic, mechanical, and/or other network elements (such as, for example, elements used in the Internet).

Individuals 102 use computing devices 104 to buy items 107 to be auctioned via network 106. Items 107 can be, for example, goods (e.g., commodity products or non-commodity products) and/or services. Individuals 102 are also referred herein as buyers 102, prospective buyers 102, potential buyers 102, and/or bidders 102. Computing devices 104 communicate via network 106 to an automated system 108 that facilitates the operation of the auction format methods, computer-implemented methods, and/or operations disclosed below. The hardware and software components in automated system 108 are typically all communicatively coupled together.

In various aspects, computing device 104 may be configured as a desktop computer 104 or may be another computing device such as, for example, a laptop or notebook computer, a personal digital assistant (PDA), a tablet, a palmtop, or a mobile computer, a mobile telephone 104, any commercially-available intelligent communications device, or the like. Computing devices 104 can be other types of devices that are not shown in FIG. 1 such as, for example, a television with Internet browsing capability, a set-top box, or other suitable types of devices. As will also be appreciated by those skilled in the relevant art(s), automated system 108 may (additionally or optionally) be connected to one or more telecommunications networks (not shown in FIG. 1) such as, for example, a GSM network, a CDMA network, a radio network, or the like. Such additional networks or optional networks would allow communication between automated system 108 and one or more mobile telephones 104h which can communicate via the Internet or other wide-area networks.

As will also be appreciated by those skilled in the relevant art(s), in an aspect, at least some various optional information screens (e.g., login, admin, account, information, resource, logout, payment, registration, communications, and/or the like) may be generated by automated system 108 in response to input from buyers 102 over network 106. In an aspect, automated system 108 would typically include a Web server running a server application at a Web site which sends out Web pages in response to Hypertext Transfer Protocol (HTTP) or Hypertext Transfer Protocol Secured (HTTPS) requests from remote browsers in various computing devices 104 being used by various bidders 102 and sellers 111. Thus, automated system 108 is able to provide a graphical user interface (GUI) to bidders 102 and sellers 111 in system 100 in the form of Web pages. These Web pages sent to the bidders' PC, laptop, mobile device, PDA, mobile phone, or the like device 104, and would result in the GUI being displayed.

Various optional data such as, for example, login and/or account information of bidders 102 and sellers 111, can be stored in a database (not shown in FIG. 1) that is accessible by the automated system 108. In another aspect, the various optional data can be stored in a memory included in (or coupled to) automated system 108.

In an aspect of the invention, automated system 108 is arranged to store, support, operate and/or execute one or more auction format modules (i.e., automated system software or auction format software), so that automated system 108 provides an auction format for selling goods and/or services (items 107) over network 106 and provides an auction format over network 106 through a game-type negotiation(s) between a seller 111 and a plurality of bidders 102, and/or perform other functions as disclosed below. The functions or operations that are performed by auction format module can be programmed by, for example, the use of a suitable software programming language as known to those skilled in the art. Automated system 108 also includes hardware components that functions with auction format module so that automated system 108 provides one or more processes, auction format methods, and/or computer-implemented methods in aspects of the invention as disclosed herein. Hardware components can include, for example, a computing device such as a server, desktop computer, and/or another computing device. In another aspect, hardware component can alternatively be formed by multiple computing devices that are distributed and communicatively coupled to each other. Those skilled in the relevant art(s) would realize that hardware component also includes other elements for executing software and/or firmware and for permitting automated system 108 to communicate along network 106. These other elements can include, for example, one or more processors, a network interface, one or more memories, one or more firmware elements, and/or other elements. Auction module software, hardware, and embedded methods in automated system 108 are also collectively referred herein as “automated system 108” for ease of discussion.

It is also understood that auction format module can be formed by a single module or formed by separate multiple sub-modules. In an aspect where auction format module is formed by multiple sub-modules, some sub-modules can be located on the client-side (e.g., in devices 104 in FIG. 1), while other sub-modules can be located on the server-side (e.g., in automated system 108 in FIG. 1). Other configurations of the locations of the sub-modules in automated system module are also possible.

As will also be appreciated by those skilled in the relevant art(s) after reading the description herein, alternate aspects of the present invention may include providing the tool for an auction format as a stand-alone system (e.g., installed on one PC) or as an enterprise system wherein all the components of communication system 100 are connected and communicate via an inter-corporate wide area network (WAN) or local area network (LAN), rather than as a Web service (i.e., an ASP model) as shown in FIG. 1.

### Auction Format Approach

In an aspect, automated system 108 will permit a computer-implemented method for an auction format over a network 106, as will be disclosed below. In an aspect, based on at least a minimal listing of information and configuration settings as configured by seller 111, automated system 108 can be configured to advantageously simulate a human seller with an asymmetric knowledge (e.g., reasonable human reasoning, non-quantifiable considerations, rational reasoning, and/or logical reasoning) of the cost and acceptable minimum price of an item 107 for sale and to advantageously negotiate with multiple prospective buyers 102 with the intention of optimizing a seller's value function that is based on item price, inventory velocity, and/or other parameters.

An aspect of the invention provides a one-to-many (i.e., single-seller to multiple-buyers), double-sided auction format (or selling method) that is implemented over a network 106. Aspects of the invention also include a system and/or business method for providing this one-to-many, double-sided auction format over a network 106 for selling an item 107 which can be a single item or a bundle of items. As mentioned above, item 107 can be a good (e.g., commodity product or non-commodity product) or a service offered for sale by a party such as a seller 111. Another party 102 that is herein referred to collectively as the “buyers” or each singly as a “buyer,” may become aware of the aforementioned item 107 and be capable of participating in the price-determination process, as described below. In this price-determination process, a seller 111 and at least one buyer 102, respectively, posts at least one “ask” price 117 and at least one “bid” price 115, where the “ask” and “bid” prices are prices at which the seller and buyer tentatively agree that they would be willing to sell or buy the item, respectively. For clarity of discussion, a seller's initial ask price or opening ask price will be referred to as an “initial ask price 117a ” or “opening ask price 117a.” The term “ask price 117” may refer to any particular ask price or ask prices or to any subsequent ask price that is submitted by seller 111 after submission of an opening ask price 117a.

Seller 111 can provide information in an item listing 114 about an item 107 for auction to bidders 102. In an aspect, automated system 108 allows a single seller 111 to auction, in an automated fashion, one or more items 107 by negotiating with multiple (i.e., a plurality of) prospective buyers (bidders) 102 (individually referred to as “bidder 102” or “buyer 102” and collectively referred to as “bidders 102” or “buyers 102”) transparently and simultaneously over a network 106. Therefore, system 108 will engage one or more bidders 102 over a communication network 106 which can be, but not necessarily, the public Internet. In the example of FIG. 1, bidders 102 will input their bids 115 via computing devices 104. Computers 104a-104d transmits bids (bid prices) 115a-115d, respectively, via network 106 to automated system 108. Computing devices 104e-104h can also transmit bids 115, via network 106, to automated system 108. Bidders 102a-102d submit bids 115a-115d, respectively, via computing devices 104a-104d. These bids 115a-115d are also referred to collectively as “bids 115.”

In an aspect of the invention, through a seller interface presented in a seller computing device 112, automated system 108 allows a seller 111 to set-up (i.e., offer) one or more items 107 for auction in item listings 114, with each listing 114 typically containing a specific item 107 (product or service) description and price attributes. The price attributes include an opening ask price 117a for an item 107. The price attributes can optionally include a reserve price.

In an aspect of the invention, through a buyer interface 300 presented in a buyer computing device 104, automated system 108 presents an item 107 for sale along with, for example, text, photographic information, photographic descriptive information, and/or other information. The information relating to item 107 and presented to computing devices 104 can vary.

In an aspect of the invention, automated system 108 presents a starting ask price 117a to prospective buyers 102 and invites prospective buyers 102 to place a bid 115 less than or equal to the starting ask price 117a. Automated system 108 publishes all ask prices 117, via network 106, to computing devices 104 of prospective buyers 102. In response to any bid 115 from any buyer 102, automated system 108 automatically publishes a new ask price 117 which differs from starting ask price 117a (if bid 115 is less than starting ask price 117a) and which is open to any bidder 102 as a prospective purchase price. In an aspect, automated system 108 publishes the interactions of bid price 115 and ask price 117 offers and counteroffers transparently through bidder interface 300, such that bidders 102 and non-participating on-lookers (who can also access network 106 via their respective computing devices) can observe as the one-seller 111 to multiple-bidders 102 double-sided auction unfolds. Therefore, in an aspect of the invention, automated system 108 provides an auction format that has the transaction transparency of a public price negotiation instead of a private price negotiation.

In an aspect, more than one buyer 102 can be made aware of an item 107 for sale, but all buyers 102 thusly made aware need not become involved in the aforesaid price-determination process of the auction. Additionally, in an aspect of the invention, seller 111 and buyers 102 need not be contractually bound to sell or buy the item at any ask price 117 or bid price 115 that they offer, respectively. As an option, both parties may retain the right to refuse to transact at their own respective offered price, whether it be the ask price or bid price.

Automated system 108, therefore, performs a price-determination process based on an auction format that is double-sided and involves one-seller-to-multiple-buyers. In an aspect, a seller 111 lists via a computing device 112 an item 107 (e.g., product or service) for sale over network 106 in such a way that multiple prospective buyers 102 can see a listing 114 of item 107 in their respective computing devices 104. The price-determination process or negotiation process then begins, and seller 111 posts “ask prices” and buyers 102 post “bid prices” until a termination condition occurs, at which time the auction ends with a sale or without a sale, depending on the rules disclosed below as configured in automated system 108 by seller 111. Typically, but not necessarily, ask prices 117 will descend from a starting ask price 117a and bid prices 115 will ascend until a termination condition occurs.

In an aspect, the aforementioned price-determination process ends when a termination condition of a “bid-ask match” occurs, that is, a seller 111 offers an ask price 117 that is equal to or less than at least one of the buyers' bid prices 115, or a buyer 102 offers a bid price 115 that is equal to or greater than at least one of seller's ask prices 117.

In an aspect, not all posted bid and ask prices need to be eligible for such a “bid-ask match” because the seller and/or the buyers may be allowed to withdraw one or more of their own respective bid or ask prices from consideration in the auction. When such a bid-ask match occurs, according to this particular aspect, as aforesaid, the seller and buyer may be contractually bound to sell and buy an item 107, respectively, or one party (seller 111 or buyer 102) or both parties (seller 111 and buyer 102) may be able to choose to withdraw their respective proposed prices (i.e., bid 115 from a buyer 102 and ask price from seller 102). If the parties do sell and buy the item, respectively, the auction ends; otherwise, according to an aspect of the invention, the price-determination process may continue or the auction may terminate with no sale. Also, according to an aspect of the invention, additional conditions may exist for an auction termination such as, for example an expiration of a pre-set time allotted for the auction as will be disclosed below.

In an aspect of the invention, the allowed sequence of the placement of bids 115 and ask prices 117 by buyers 102 and seller 111, respectively, is unrestricted in a general version of network system 100. Therefore, the allowed sequence of the placement of bids and ask prices 117 may vary. For example, according to some aspects of the invention, seller 111 and buyers 102 may be allowed to offer prices at any time, whereas in other aspects of the invention there may be a forced progression of seller 111 placing one offer (ask price) 117, then a buyer 102 placing one offer (bid) 115, and then seller 111 placing a counteroffer (subsequent ask price) 117 to that one buyer offer 115, and so forth in an organized offer-counteroffer sequence. In another aspect of the invention, a second buyer 102b may be allowed to place a second offer (second bid) 115b immediately after a first buyer 102a has placed a first offer (first bid) 115a via network 106, where the second buyer 102b can place the second offer 115b even before the seller 111 has placed a counteroffer 117 in response to the first offer 115a.

In an aspect, the seller's ask prices 117 may be applicable (offered) to all buyers 102, or ask prices 117 may be offered only to one or more specific buyers 102 (as configured by seller 111 via automated system 108), and these ask prices 117 offered to one or more specific buyers 102 may be visible or invisible to the other buyers 102 (as also configured by seller 111 via automated system 108). For example, an ask price 117 offered only to buyer 102a can be visible or invisible (as configured in automated system 108) to buyers 102b, 102c, and 102d. As another example, an ask price 117 offered only to buyers 102a and 102b can be visible or invisible (as configured in automated system 108) to buyers 102c and 102d.

Additionally, all buyers' bids 115 may be visible to all the other buyers 102 (that did not present the particular bid) or to all buyers 102, or some or all of buyers' bids 115 may be invisible to some buyers 102, or some or all of buyers' bids 115 may be invisible to all of the other buyers 102 (depending on seller's configuration of automated system 108). For example, as configured in automated system 108, the following conditions are possible: (1) all bids 115a-115d may be visible to all other buyers that did not present the bid or to all buyers 102; (2) some or all of bids 115a-115d can be invisible to some buyers 102 (e.g., bid 115a would be invisible to buyer 102b only); or (3) some or all of bids 115a-115d may be invisible to all of the other buyers 102 (e.g., bid 115a of buyer 102a would be invisible to all other buyers 102b-102d). However, in these aspects of the invention, the aforementioned price-determination process is required be open to participation by exactly one seller 111 and more than one buyer 102, and both buyers 102 and seller 111 are required to be able to post at least one bid 115 and ask price 117, respectively.

In an aspect of the invention, any of the following three termination conditions will terminate an auction: (i) a bid-ask match where a bid price from a buyer matches (or exceeds) the ask price provided by the automated system 108; (ii) a bid-ask match where the automated system 108 publishes an ask price that matches (or is less than) a bid price; or (iii) the time clock for an auction runs out without a winning bid price. In another aspect, ask price 117 can be provided by a seller 111 via automated system 108. In yet another aspect, ask price 106 can be provided by automated system 108 in an automatic fashion so that seller 111 only inputs an initial ask price 117a and is not required to input any ask prices 117 subsequent to initial ask price 117a because automated system 108 will provide such subsequent ask prices that are counteroffers to any bids 115 received from buyers 102.

The above-mentioned termination condition (i) may occur when any bidder 102 places a bid that is greater than or equal to the ask price, and the automated system 108 accepts the bid from the bidder 102, ends the auction, and closes a contract for bidder 102 who placed the accepted bid to purchase an item 107 at the accepted bid price.

The above-mentioned termination condition (ii) may occur when automated system 108 publishes an ask price 117 that is less than or equal to the last bid price 115 and the automated system 108 thereby accepts the last bid price 115, ends the auction, and closes a contract for bidder 102 who placed the accepted bid to purchase an item 107 at the accepted bid price.

The above-mentioned termination condition (iii) may occur when a pre-set maximum auction time allowance has elapsed and automated system 108 ends the auction without a winning bidder 102. The pre-set maximum time allowance is selected by seller 111 via computer 112 and automated system 108.

In another aspect of the invention, a seller 111 can provide more flexibility for bidders 102 by setting the pre-set maximum auction time allowance to a relatively long time period or can configure automated system 108 to provide an auction format without any preset maximum auction time allowance.

In another aspect of the invention, additional termination rules or alternative terminations rules from those disclosed above can terminate an auction and can be configured by a seller 111 via automated system 108.

Automated system 108 advantageously solves the “one-sided” nature of conventional online (networked) auctions such as the traditional face-to-face auction commonly simulated on the Internet and other one-sided Internet auctions. These conventional online auctions rely on the bidders to engage against each other while the seller or the system merely maintains a tally of the bids and publishes the results without engaging the bidders on the price. In contrast, in an aspect of the invention, automated system 108 introduces and provides a novel type of double-sided auction format that advantageously allows a single seller 111 to actively and interactively engage with multiple bidders 102 for an item 107 to be sold and that advantageously provides a more dynamic (e.g., less time consuming) and more enjoyable experience for bidders 102 in the auction process. Therefore, an aspect of the invention provides a novel selling method by use of a single-seller-to-multiple-buyers (i.e., one-to-many), double-sided auction format.

An aspect of the invention provides an auction format over a network through game-type negotiations and/or a game-like environment. Seller 111 performs price negotiations for an item 107 with a plurality of bidders 102 in a game-like auction environment. In an aspect, a “game” commences when seller 111 publishes (via network 106) an item 107 for sale at an initial (starting) ask price 117a that is available to any bidder 102. In an aspect, a first bid 115 from a bidder 102 is maintained or locked by automated system 108 until seller 111 accepts the first bid 115 or seller 111 counters with a new ask price 117 that is once again available to any bidder 102. Therefore, a dynamic offer versus counteroffer game unfolds with buyers 102 publishing bid prices 115 that are typically rising and seller 111 publishing ask prices 117 that are typically descending. In an aspect, the auction for item 107 will terminate upon the expiration of a pre-set auction time value of a game clock visible to bidders 102. In another aspect of the invention, seller 111 sets the pre-set auction time value to a relatively longer time period in order to provide additional flexibility for bidders 102. In yet another aspect of the invention, seller 111 has the option to not provide a pre-set auction time value requirement so that the auction process is not limited by any time frame.

In another aspect of the invention, the auction game terminates when: (i) any buyer bid 115 at least equals to the most recent ask price 117, resulting in a sale of an item 107; (ii) a seller 111 accepts the latest bid 115, resulting in a sale of an item 107; or (iii) the pre-set auction time value expires without a match between a bid 115 and ask price 117. Given the single-seller, single-item, and single-winning-bidder restrictions of conventional auctions, along with the rule that a bid-ask match terminates the auction game even when time remains and has not expired on clock, this aspect of the present invention provides an advantageous game dynamic where buyers 102 are prevented from bidding too low in price and too slow such that seller 111 accepts another buyer's bid at a bid price that other buyers would have willingly matched or exceeded.

Although in the drawings, illustrations of personal computers (or certain mobile devices such as PDAs or laptops/notebooks) are used to represent the seller's node and bidders' node of system 100 and network 106, aspects of the invention are not limited to these particular example devices. For example, other types of computing devices such as, for example, mainframe computers, workstations, other types of mobile computing devices, and/or any other suitable devices that can connect to a network may be used by seller 111 and/or bidders 102 to connect to network 106 and engage in the aforementioned price-determination process. Also, although FIG. 1 assumes that automated system 108 performs a method for automatically negotiating on behalf of a seller 111, as described further below, this automatic auction format method is not necessarily included in other aspects of the invention.

As will be appreciated by those skilled in the relevant art(s) after reading the description herein, the game mechanics-based, 1-to-many, double-sided auction provided by system 108 creates a cooperation-competition scenario among buyers whereby they cooperate against seller, essentially crowd-sourcing a lower price through a series of bids lower than the asks. Such sellers, however, simultaneously compete because one (and only one) buyer bid will win. Further, a buyer may observe that the plurality of other buyers are bidding slowly and incrementally upward, while the seller is responding slowly with incrementally downward ask prices. At any time, a buyer could “defect” from the compliant incremental bid behavior of the plurality and place a bid near the mid-point, or at least substantially higher than the incremental bidding would suggest, in an attempt to “steal” the win. Given that the seller can close the auction via bid-ask match, this sets-up an unconventional game mechanic of cooperation and competition among buyers. Still further, the above-described game mechanics takes place in the presence of an ever-ticking clock that threatens to make losers of all bidders should time expire prior to a bid-ask match.

### Exemplary Methodology

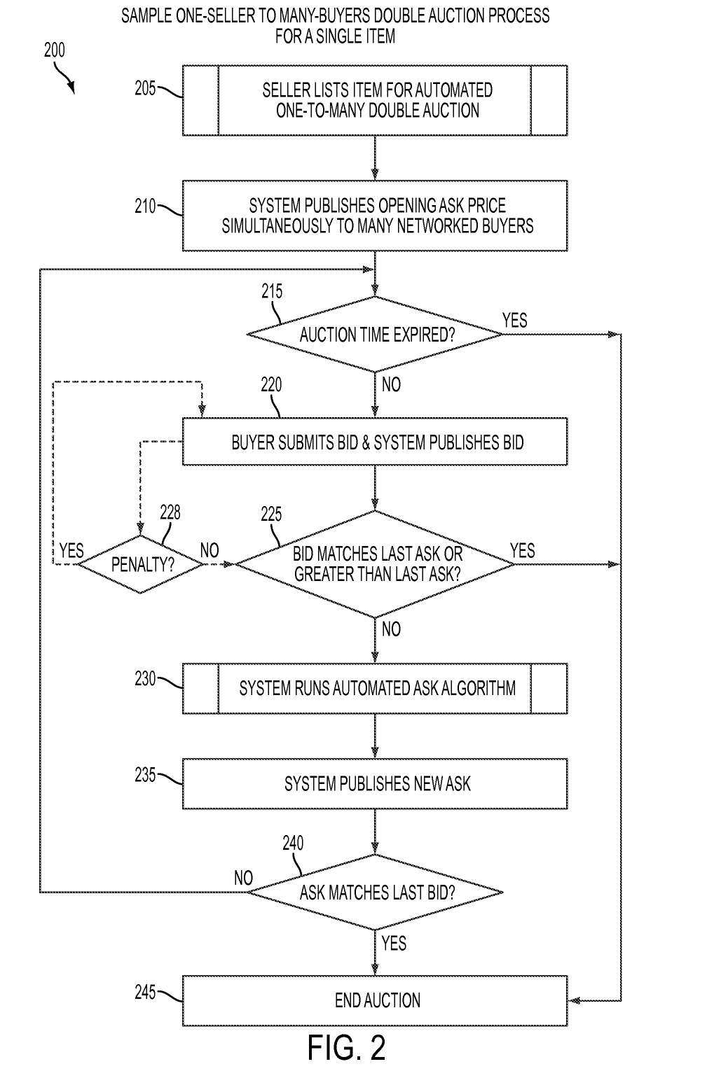

In one aspect of the invention, a seller 111 is represented in the aforesaid price-determination process by automated system 108. As similarly disclosed above, automated system 108 provides a negotiation process on a seller's behalf with bidders 102. In other words, automated system 108 “negotiates” with the buyers on the seller's behalf by choosing and posting (publishing) the opening ask price 117a and subsequent ask prices 117, terminating the auction, and, if applicable, making the sale without necessitating any seller input beyond seller 111 inputting an initial listing of an item 107 and opening ask price 117a. In an aspect of the invention, one such possible automated system 108 allows a method 200 (as depicted in FIG. 2) having a flow of execution that one such automated system 108 would follow in order to participate in the aforesaid price-determination process and subsequently terminate the auction. However, in another aspect of the invention, the automated auction format provided in method 200 is omitted and seller 111 can instead directly and manually provide, via network 106, any offer and counteroffers to bidders 102.

Referring to FIG. 2, a flow diagram of an automated auction format method 200, according to an aspect of the present invention, is shown. In this aspect, in step 205, seller 111 initiates the automated selling process by listing an item 107 for an automated one-to-many double-sided auction. Block 205 includes seller 111 inputting, into automated system 108, the information associated with item 107 to be sold to buyers 102. In an aspect, seller 111 inputs this information by use of computing device 112 that is communicatively coupled to automated system 108. This includes seller 11 inputting an opening ask price 117a, and a time value into automated system 108 in step 205.

Then, in step 210, automated system 108 publishes an opening (initial) ask price 117a simultaneously to many networked potential buyers 102 that can access network 106 and opens item 107 for bidding by potential buyers 102.

In step 215, automated system 108 checks if a timer (that sets the auction time) has run out. If the timer has expired, then the auction is terminated with no sale as shown in step 245. If timer has not expired, then automated system 108 proceeds to step 220. In another aspect of the invention, seller 111 can set the timer to a relatively longer time period or omit any auction time requirements in which case the auction length is not constrained by a time value.

In step 220, a buyer 102 submits a bid 115 to automated system 108, and automated system 108 then publishes the bid 115 via network 106 so that all bids 115 are visible to all buyers 102 or to less than all of buyers 102, depending on the configuration selected in automated system 108 by seller 111 in step 205.

In step 225, automated system 108 then checks if the bid is greater than or equal to the last ask price. If the bid is greater than or equal to the last ask price, then the auction terminates with a sale to the buyer that placed the aforesaid bid as shown in step 245. If the bid is less than the last ask price, then automated system 108 proceeds to step 230 where a new ask price is chosen.

Optionally or additionally, in an aspect of the invention, a bidder penalty feature (or “buyer yellow card” feature) in an optional step 228 checks if a buyer has submitted a threshold number “sham bids” which can be, for example, bids that are not sincere or bids that are below a minimum threshold bid price. In this aspect of the invention, the check for a sham bid is typically first performed before a bid is published within system 100, and network system 100 will not publish any sham bid that exceeds the threshold number of sham bids. A buyer who incurs a penalty in step 228 is required to submit a new bid, via automated system 108, in step 220. (The threshold number of sham bids and the minimum threshold bid price are parameters that are configured by seller 111 in step 205 to automated system 108.) This buyer penalty feature has an advantage of minimizing unnecessary network traffic, system load, and inconvenience of seller 111 and other buyers 102. However, in an aspect of the invention, this buyer penalty feature in step 228 can be omitted.

In step 230, automated system 108 runs an automated ask price algorithm for choosing a new ask price in response to a bid. In an aspect of the invention, various methods for determining new ask prices are possible. One example of a method used in step 230 for determining a new ask price 117 by automated system 108 is shown in Equation (1):

ask=previous ask−(previous ask−target price)*((bid−previous bid)/(target price−previous bid)). (1)

In Equation (1), target price is a variable determined by the following method (where initial target price was inputted by seller 111 in initial step 205 and reserve price is the price below which seller 111 is not willing to sell, as also inputted in step 205). The target price is calculated by Equation (2):

target price=initial target price−(time remaining/total time)*(initial target price−reserve price). (2)

As will be appreciated by those skilled in the relevant art(s) after reading the description herein, other methods may be used to calculate ask prices 117 that are subsequent to opening ask price 117a. Therefore, the automated ask algorithm in step 230 is not limited to Equation (1) and Equation (2). In fact, as will be appreciated by those skilled in the relevant art(s) after reading the description herein, in alternate aspects only a portion of Equation (1) and Equation (2) may be utilized to determine a new target ask or target price, respectively (e.g., applying a multiplier to one or more variables within the equation or the resulting value). (In an alternate aspect, seller 111 may manually enter a modified ask price without relying on automated system 108.)

Next, in step 235, automated system 108 publishes, via network 106, a new ask price 117 (as calculated according to Equation (1)) to computing devices 104 of all buyers 102.

In step 240, automated system 108 checks if new ask price 117 is less than or equal to the last bid. If new ask price 117 is less than or equal to the last bid, then the auction terminates with a sale to the buyer that placed the aforementioned bid as shown in step 245. If new ask price 117 is not less than the last bid, then automated system 108 proceeds to the next step in step 215, namely, looping back to step 215 where automated system 108 checks if the auction time has expired and proceeds subsequently as similarly disclosed above.

Automated system 108 thus continues the auction until one of the above-mentioned three auction termination conditions is fulfilled, and the auction ends with or without a sale. In another aspect of the invention, automated system 108 can perform an automated one-seller to many-buyers, double-sided auction format that varies from method 200.

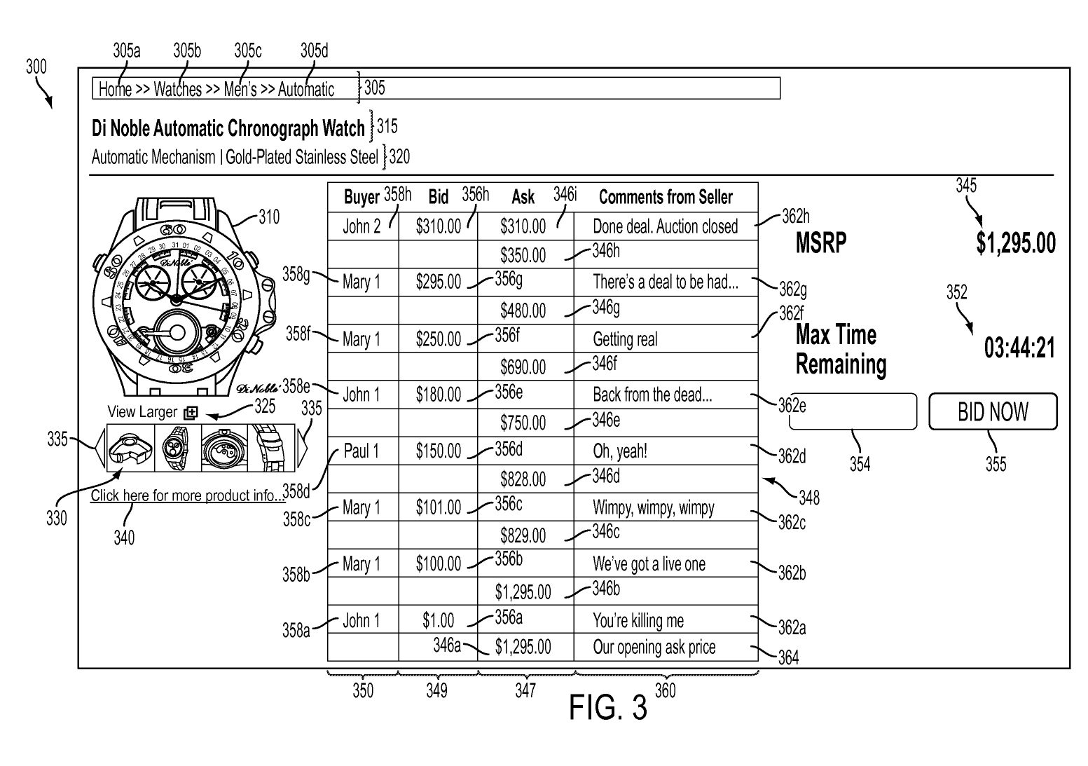

In an aspect, when automated system 108 calculates an ask price, automated system 108 may also optionally calculate an anthropomorphic text comment (or other comment) to publish alongside the ask price, as shown in FIG. 3 and as disclosed below.

### Rule-Based Alternate Methodologies

In various aspects of the invention, four additional variations for communications system 100 are presented below for their particular utility and for the sake of illustration. However, other variations in communications system 100 are also possible. Additionally, although these various aspects may occasionally assume the existence of an automated system 108 negotiating on behalf of a seller 111 as aforesaid, these various aspects may also be used if seller 111 participates directly in the negotiation process with buyers 102 without the use of automated steps as disclosed in method 200 and/or without the use of software, firmware, and/or hardware in automated system 108 other than those required for seller 111 to offer and counteroffer, via network 106, with buyers 102. For example, automated system 108 can instead be configured as a seller's computing device that permits seller 111 to directly offer and counter offer and otherwise participate directly in the negotiation and auction processes, via network 106, with buyers 102, where automated system 108 does not include any or at least some of the automated auction functions as disclosed above.

In an aspect, the first three of the four variations feature a maximum auction time that is made visible to buyers 102. Also, in these aspects, the following conditions may also be applicable. Seller 111 and buyers 102 are contractually bound to sell and buy, respectively, an item 107 at any ask price or bid price that they publish and that is accepted by the opposite party. No ask price may be greater than any previously published ask price in that particular auction, and no bid price may be less than any previously published bid price in that auction, regardless of which buyer posts the bid. Additionally, the auction is conducted on the seller's node in a network (e.g., a seller's website on the Internet), and any party that visits the node or website is free to participate as a buyer. The full history of bid and ask prices, including time published, is immediately visible and applicable to all parties. No bid or ask prices may be withdrawn from consideration by the party that placed the offer. Finally, one ask price 117 will be placed by seller 111 in response to each bid 115. In other aspects, any of the above conditions or combination of conditions can be omitted or varied as selected by seller 111. Possible examples of variations of aspects of the invention are now disclosed below.

In an aspect, the first of these four variations has one additional rule: after a bid 115 is placed by any buyer 102 (i.e., the “most recent bid”), no other buyer bid 115 will be considered until seller 111 has published an ask price 117 that corresponds to that most recent bid 115. This additional rule creates a game-show-type dynamic; a buyer must race to “buzz in” a bid immediately after the seller posts a new ask price, creating urgency and compelling the auction to advantageously proceed rapidly. In this first variation, the seller, whether automated via the steps in method 200 or not automated, would usually deliberate for at least a few seconds before posting an ask price in order to build suspense in the auction.

In the second of the four variations, no additional rules exist. Instead, the automated seller (as performed by automated ask algorithm in step 230 or method 200) takes into account, when calculating a new ask price 117, the actual most recent ask price 117 and bid price 115 that were visible to a buyer 102 when the bid was placed. In this way, for example, if two buyers submit bids that are close together at nearly the same time, and the second bid is slightly higher than the first bid, the seller would not respond with a new ask price to the second bid as if it were “tightfisted,” but would take into account the factors that—due to data transfer speeds, computation time, and browser refresh rates—the second buyer did not see the first buyer's bid when the second buyer submitted that second bid. In this second variation, the seller would usually post an ask price immediately after receiving a bid, without suspenseful deliberation, in an attempt to respond to each new bid before another bid is submitted.

In the third of the four variations, one less rule exists: the rule that one ask price will be placed by seller 111 in response to each bid is eliminated. Instead, when a rapid succession of bids is entered, the seller will often respond to the bids as if the highest of those bids was the only bid placed and seller is not required to reply to each of the other bids. Additionally, if the bidding process slows, the seller may post more than one ask price in response to one bid (after a suitable pause) in order to stimulate bidding. In this third variation, the seller would usually deliberate for a short time before posting each ask price in order to determine if other bids are to follow closely after the one bid to which the seller is currently formulating a response.

In the fourth variation, none of the above-described rules apply. As before, seller 111 and buyers 102 are contractually bound to sell and buy an item 107 at any ask price 117 or bid price 115 that they publish and that is accepted by the opposite party. Also as before, the auction is conducted on the sellers node (e.g., a seller's website on the Internet), and any party that visits the node (e.g., website) is free to participate as a buyer. However, only the lowest ask price, each bidder's highest bid, and the buyer's own bidding history are visible to each buyer, and buyers may offer bids at any time and for any amount. The highest bid is still the only bid that can actually be accepted by the seller; however, buyers may communicate their dissatisfaction with the current ask price to the seller by placing low bids or even withdrawing higher bids that they have placed. Similarly, the seller may, at any time, post an ask price of any amount, so if the buyers bid low, the seller may actually raise the ask price to protest the buyers' low bids. Additionally, no maximum auction length exists; instead, the seller reserves the right to terminate the auction with no sale at any time. Finally, the seller reserves the right to post different ask prices to different buyers (where the different ask prices are nevertheless visible but not applicable to all buyers), primarily in order to encourage cooperation by offering “special prices” to valued customers. With fewer rules and less constraints, a main advantage of this fourth variation is that the buying-and-selling process may feel more “natural” to some buyers, and some of the rules, such as the seller's ability to post different ask prices to different buyers and all parties' ability to withdraw their own best offer as a “punishment” for uncooperative behavior on the part of the other party, may appeal to the more competitive among prospective buyers.

### Buyer Interface

Referring to FIG. 3, a block diagram of an exemplary buyer interface 300 (as seen from a buyer's computing device 104), according to an aspect of the present invention, is shown. Automated system 108 is able to provide interface 300 as, for example, a graphical user interface (GUI) to computing devices 104 in the form of Web pages. These Web pages sent to the bidders' PC, laptop, mobile device, PDA, mobile phone, or the like device 104, and would result in the GUI being displayed.

In an aspect, interface 300 includes at least some of the following fields. However, at least some of these fields can be varied, omitted added or substituted. Topic field 305 can include a home page link 305a which will display a home page for providing an auction format for items 107 according to aspects of the invention. Links 305a-305d are additional links that provide web pages for categories and sub-categories of items 107. Shown in FIG. 3 is an example item 107 for sale—a men's automatic watch 310. Therefore, link 305a provides a web page presenting all watches available for auction by seller 111.

In an aspect, interface 300 also displays additional details of the item for sale. Field 315 displays the manufacturer and product information. For example, item 107 is a Di Noble® automatic chronograph watch that is available for auction. Field 320 displays particular features of the item such as, for example, an automatic mechanism and gold-plated stainless steel material.

Field 325 allows a buyer 102 to view larger- and smaller-sized images of item 107. Images 330 provide additional pictures of item 107 in different image sizes and different viewpoints. Tabs 335 allows buyers 102 to view additional pictures of item 107. Link 340 provides more product information about item 107.

The MSRP of item 107 is listed in field 345. A first ask price (i.e., opening ask price 117a) is listed in field 346a of ask price column 347 that lists a history of all ask prices for item 107 is also shown. A centrally located table 348 displays ask price column 347 and other information disclosed below. In column 347, various example ask prices 346a-346i are shown. The first ask price in field 346a is, for example, reasonably equal to the MSRP.

A bid history in the auction is displayed in column 349 and participating bidders are displayed in column 350.

The maximum time remaining in the auction is displayed in field 352, and this auction time value proceeds in a countdown manner. Field 354 allows a buyer 102 to submit a bid for item 107, and tab 355 allows the bid in field 354 to be submitted in the auction.

Fields 356a-356h display bids from identified buyers in fields 358a-358h, respectively. In the example auction presented by interface 300, buyer “John 1” is shown as a bidder in fields 358a and 358e; buyer “Mary 1” is shown as a bidder in fields 358b, 358c, 358f, and 358g; buyer “Paul 1” is shown as a bidder in field 358d; and buyer “John 2” is shown as a bidder in field 358h. Buyer “John 1” in field 358a is shown as submitting the first bid of $1.00 in field 356a, while buyer “Mary 1” in field 358b is shown as submitting a subsequent bid of $100.00 in field 356b. Other subsequent bids are also shown in column 349. The bids in fields 356a-356h are ascending in value, while ask prices in fields 346a-346i are descending in value.

In an aspect, table 348 may also optionally include a column 360 that displays text comments (and/or other feedback) from sellers 111 in response to bids in column 349 from buyers 102. For example, fields 362a-362h displays comments from sellers 111 in response to bids in fields 356a-356h from buyers 102, respectively. Field 364 in column 360 displays an opening comment of seller 111 with regards to the opening ask price in field 346a.

Other variations or configurations in interface 300 are possible.

As will be appreciated by those skilled in the relevant art(s) after reading the description herein, variations of various aspects of the present invention are possible for the one-seller-to-many-buyers, double-sided auction format as provided by system 100.

As will be appreciated by those skilled in the relevant art(s) after reading the description herein, automated system 108 would also provide a seller interface to a seller computing device 112. That is, a seller interface (not shown) may be seen on a seller computing device 112, and may generally have a similar format as interface 300, but with particular different input fields that would apply to a seller. For example, a seller interface may have an ask price field for receiving ask price values instead of bid values.

### Example Environment

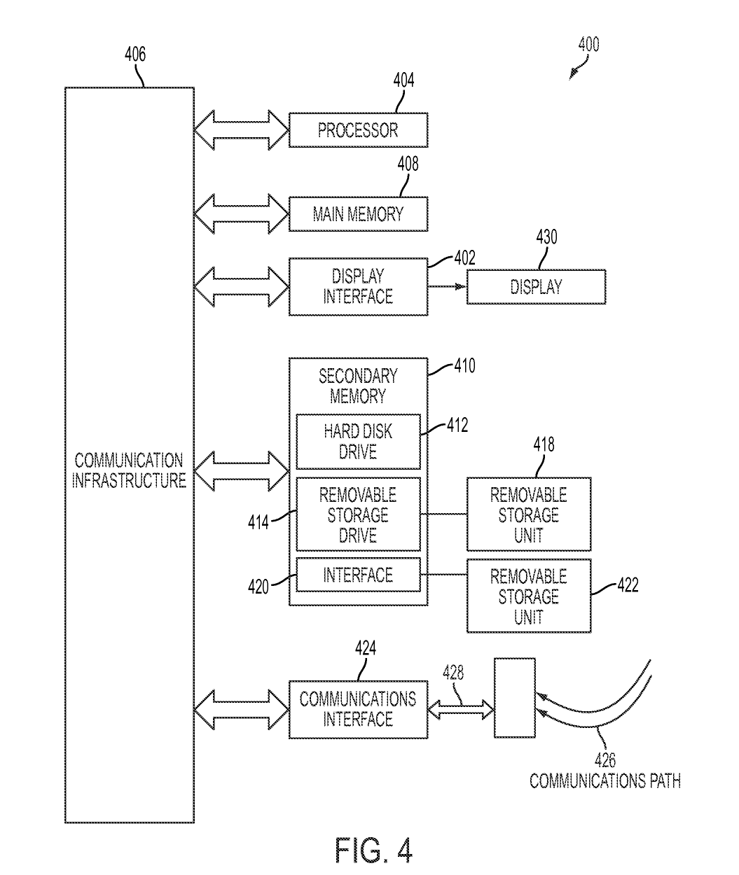

Referring to FIG. 4, a block diagram of an exemplary computer system 400 useful for implementing an aspect of the present invention is shown. In one aspect, system 400 may be directed toward one or more computer systems capable of carrying out the functionality (e.g., system 100, method 200, interface 300, or any part(s) or function(s) thereof) described herein. An example of a computer system 400 is shown in FIG. 4. Computer system 400 includes one or more processors, such as processor 404. Processor 404 may be connected to a communication infrastructure 406, such as a communications bus or network, for example. Various software aspects are described in terms of this exemplary computer system. After reading this description, it will become apparent to a person skilled in the relevant art(s) how to implement the invention using other computer systems and/or architectures.

Computer system 400 can include a display interface 402 that forwards graphics, text and other data from communication infrastructure 406, or from a frame buffer (not shown), for display via display unit 430. Computer system 400 may also include a main memory 408, preferably a random access memory (RAM), and may further include a secondary memory 410. Secondary memory 410 may include, for example, a hard disk drive 412 and/or a removable storage drive 414, representing a floppy disk drive, a magnetic tape drive, or an optical disk drive, for example. Removable storage drive 414 reads from and/or writes to a removable storage unit 418 in a manner well known in the relevant art. Removable storage unit 418 represents a floppy disk, magnetic tape, or an optical disk, which is read by and written to by removable storage drive 414. As can be appreciated, removable storage unit 418 includes a computer usable storage medium having stored therein computer software and/or data.

In alternative aspects, secondary memory 410 may include other similar devices for allowing computer programs or other instructions to be loaded into computer system 400. Such devices may include, for example, a removable storage unit 422 and an interface 420. Examples of such may include a program cartridge and cartridge interface, such as may be found in video game devices, a removable memory chip, such as an erasable programmable read only memory (EPROM), or programmable read only memory (PROM), and associated socket and other removable storage units 422 and interfaces 420, which allow software and data to be transferred from the removable storage unit 422 to computer system 400.

Computer system 400 may also include a communications interface 424. Communications interface 424 allows software and data to be transferred between computer system 400 and external devices. Examples of a communications interface 424 may include a modem, a network interface such as an Ethernet card, a communications port, and a Personal Computer Memory Card International Association (PCMCIA) slot and card. Software and data transferred via communications interface 424 are in the form of non-transitory signals 428 which may be electronic, electromagnetic, optical or other signals capable of being received by communications interface 424. Signals 428 may be provided to communications interface 424 via a communications path or channel 426. Channel 426 may carry signals 428 and may be implemented using wire or cable, fiber optics, a telephone line, a cellular link, a radio frequency (RF) link, and other communications channels.

In this document, the terms “computer program medium” and “computer usable medium” are used to generally refer to media such as removable storage drive 414, a hard disk installed in hard disk drive 412, and signals 428. These computer program products provide software to computer system 400, wherein the present invention is directed to such computer program products.

Computer programs (also referred to as computer control logic), may be stored in main memory 408 and/or secondary memory 410. Computer programs may also be received via communications interface 424. Such computer programs, when executed, enable computer system 400 to perform the features of the present invention, as disclosed herein. In particular, the computer programs, when executed, enable processor 404 to perform the features of the present invention. Accordingly, such computer programs represent controllers of the computer system 400.

In an aspect where the invention is implemented using software, the software may be stored in a computer program product and loaded into computer system 400 using removable storage drive 414, hard drive 412 or communications interface 424. The control logic (software), when executed by processor 404, causes processor 404 to perform the functions of the invention as described herein.

In another aspect, the invention is implemented primarily in hardware using, for example, hardware components such as application specific integrated circuits (ASICs). Implementation of the hardware state machine so as to perform the functions described herein will be apparent to persons skilled in the relevant art(s).

As will be apparent to one skilled in the relevant art(s) after reading the description herein, the computer architecture shown herein in various drawings may be configured as a desktop, a laptop, a server, a tablet computer, a PDA, a mobile computer, an intelligent communications device or the like. In yet another aspect, the invention may be implemented using a combination of both hardware and software.

### CONCLUSION

While various aspects of the present invention have been described above, it should be understood that they have been presented by way of example and not limitation. It will be apparent to persons skilled in the relevant art(s) that various changes in form and detail can be made therein without departing from the spirit and scope of the present invention. Thus, the present invention should not be limited by any of the above described exemplary aspects, but should be defined only in accordance with the following claims and their equivalents.

In addition, it should be understood that the figures in the attachments, which highlight the structure, methodology, functionality and advantages of the present invention, are presented for example purposes only. The present invention is sufficiently flexible and configurable, such that it may be implemented in ways other than that shown in the accompanying figures.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present invention in any way.

What is claimed is:

1. A system for facilitating a one-to-many, double-sided online auction, comprising:
an auction server configured to provide an ask price for an item presented for sale in the auction, via a network, to a plurality of computing devices being utilized by a plurality of bidders;
wherein the auction server is further configured to receive, via the network, a plurality of bids for the item from the plurality of computing devices;
wherein the auction server is further configured to provide a modified ask price, via the network, to at least some of the plurality of computing devices, wherein the modified ask price is based on at least one of the plurality of bids;
wherein the auction server is further configured to receive, via the network and subsequent to providing the modified ask price, at least an additional bid from at least one of the plurality of computing devices;
wherein the auction server is further configured to terminate the auction in response to a termination condition; and
wherein the termination condition is one of: a bid-ask match where a bid received by the auction server from one of the plurality of bidders is at least equal to one of: the ask price, and the modified ask price; and the expiration of an auction time clock.

2. The system of claim 1, wherein the ask price is an input received by the auction server from a seller of the item, and wherein the auction server is further configured to provide a modified ask price by one of: increasing the ask price; and decreasing the ask price.

3. The system of claim 2, wherein the auction server is further configured to receive an initial target price and a reserve price for the item presented for sale in the auction from the seller.

4. The system of claim 3, wherein the auction server is further configured to determine the modified ask price utilizing at least a portion of the equation:
modified ask price=previous ask price−(previous ask price−target price)*((bid−previous bid)/(target price−previous bid)).

5. The system of claim 4, wherein the auction server is further configured to determine a new target price based on at least a portion of the following equation:
new target price=initial target price−(time remaining/total time)*(initial target price−reserve price).

6. The system of claim 4, wherein the auction server is further configured to provide the modified ask price to each of the plurality of computing devices, wherein the auction server receives at least one additional bid subsequent to providing the modified ask price.

7. The system of claim 4, wherein the auction server is further configured to provide the modified ask price to less than all of the plurality of computing devices, wherein the auction server receives at least one additional bid subsequent to providing the modified ask price.

8. The system of claim 1, wherein the plurality of computing devices the auction server is configured to provide an ask price to, via the network, comprises at least one of: a desktop computer; a laptop computer; a notebook computer, a personal digital assistant; a tablet; a mobile telephone; and a mobile computer.

9. The system of claim 1, wherein the network is the global, public Internet; and wherein the item presented for sale in the auction comprises one of: a good and a service.

10. The system of claim 1, wherein the auction provides a price-determination through a game mechanics-based negotiation between a seller of the item and the plurality of buyers.

11. The system of claim 1, wherein the auction server is further configured to permit any bid received from one of the plurality of bidders to be visible to the remaining plurality of bidders.

12. The system of claim 1, wherein the auction server is further configured to permit any bid received from one of the plurality of bidders to be visible to less than all of the remaining plurality of bidders.

13. The system of claim 1, wherein the auction server is further configured to prohibit any bid received from one of the plurality of bidders from being visible to any of the remaining plurality of bidders.

14. The system of claim 1, wherein the auction server is further configured to prevent the publication of a sham bid.

15. The system of claim 1, wherein the auction server is further configured to provide a particular modified ask price in response to each bid.

16. The system of claim 1, wherein the auction server is further configured to provide a particular modified ask price in response to a pair of bids submitted within a small time frame, wherein the pair of bids comprises a first bid and a second bid submitted after the first bid, and wherein the particular modified ask price is based on a value of the first bid.

17. The system of claim 1, wherein the auction server is further configured to provide a particular modified ask price in response to a plurality of bids, and wherein the particular modified ask price is based on the highest value among the plurality of bids.

18. The system of claim 1, wherein the auction server is further configured to permit a lowest ask price and a corresponding highest bid received from of each of the plurality of bidders to be visible to each of the plurality of bidders and a seller of the item.

19. A computer implemented method for facilitating a one-to-many, double-sided online auction, comprising the steps of:
providing, by an auction server and via a network, an ask price for an item presented for sale in the auction to a plurality of computing devices being utilized by a plurality of bidders;
receiving, at the auction server and via the network, a plurality of bids for the item from the plurality of bidders;
providing, by the auction server and via the network, a modified ask price to at least some of the plurality of computing devices, wherein the modified ask price is based on at least one of the plurality of bids;
receiving, at the auction server, via the network and subsequent to providing the modified ask price, at least an additional bid from at least one of the plurality of computing devices; and
terminating, by the auction server, the auction in response to a termination condition;
wherein the termination condition is one of: a bid-ask match where a bid received by the auction server from one of the plurality of bidders is at least equal to one of: the ask price, and the modified ask price; and the expiration of an auction time clock.

20. The method of claim 19, further comprising the steps of:
receiving, by the auction server and via the network, the ask price from a seller of the item;
determining, by the auction server and via the network, a modified ask price by one of: increasing the ask price; and decreasing the ask price.

21. The method of claim 20, further comprising the step of:
receiving, by the auction server and via the network, an initial target price and a reserve price for the item presented for sale in the auction from the seller.

22. The method of claim 21, further comprising the step of:
determining, by the auction server, the modified ask price utilizing at least a portion of the equation:
modified ask price=previous ask price−(previous ask price−target price)*((bid−previous bid)/(target price−previous bid)).

23. The method of claim 22, further comprising the step of:
determining, by the auction server, a new target price based on at least a portion of the following equation:
new target price=initial target price−(time remaining/total time)*(initial target price−reserve price).

24. The method of claim 22, further comprising the step of:
providing, by the auction server, the modified ask price to each of the plurality of computing devices, wherein the auction server receives at least one additional bid subsequent to providing the modified ask price.

25. The method of claim 22, further comprising the step of:
providing, by the auction server, the modified ask price to less than all of the plurality of computing devices, wherein the auction server receives at least one additional bid subsequent to providing the modified ask price.

26. The method of claim 19, wherein the plurality of computing devices comprises at least one of: a desktop computer; a laptop computer; a notebook computer, a personal digital assistant;
a tablet; a mobile telephone; and a mobile computer.

27. The method of claim 19, wherein the network is the global, public Internet; and wherein the item presented for sale in the auction comprises one of: a good and a service.

28. The method of claim 19, wherein the auction provides a price-determination through a game mechanics-based negotiation between a seller of the item and the plurality of buyers.

29. A computer program product comprising computer usable medium encoded in a computer having control logic stored therein for causing the computer to facilitate a one-to-many, double-sided online auction, said control logic comprising:
first computer readable program code means for causing the computer to provide, via a network, an ask price for an item presented for sale in the auction to a plurality of computing devices being utilized by a plurality of bidders;
second computer readable program code means for causing the computer to receive, via the network, a plurality of bids for the item from the plurality of bidders;
third computer readable program code means for causing the computer to provide, via the network, a modified ask price to at least some of the plurality of computing devices, wherein the modified ask price is based on at least one of the plurality of bids;
fourth computer readable program code means for causing the computer to receive, via the network and subsequent to providing the modified ask price, at least an additional bid from at least one of the plurality of computing devices; and
fifth computer readable program code means for causing the computer to terminate the auction in response to a termination condition;
wherein the termination condition is one of: a bid-ask match where a bid received by the auction server from one of the plurality of bidders is at least equal to one of: the ask price, and the modified ask price; and the expiration of an auction time clock.

30. The computer program product of claim 29, further comprising:
sixth computer readable program code means for causing the computer to receive, via the network, the ask price from a seller of the item;
seventh computer readable program code means for causing the computer to determine, via the network, a modified ask price by one of: increasing the ask price; and decreasing the ask price.
